(19) United States
(12) Patent Application Publication
(10) Pub. No.: US 2006/0241228 A1
(43) Pub. Date: Oct. 26, 2006

(54) Polyurethane dispersions having improved film-forming properties

(75) Inventors: Rolf Gertzmann, Leverkusen (DE); Christoph Irle, Sant Just Desvern (ES); Rolf Roschu, Willich (DE)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/407,818

(22) Filed: Apr. 20, 2006

(30) Foreign Application Priority Data
Apr. 25, 2005 (DE) 102005019397.8

(51) Int. Cl. C08K 5/06

(52) U.S. Cl. 524/376; 524/591

(57) ABSTRACT

The present invention relates to a process for preparing an aqueous coating composition by I) preparing a polyurethane dispersion that is free from NMP and other solvents by
1) preparing in a first step an NCO prepolymer solution which has a concentration of 66% to 98% by weight in a solvent having a boiling point of below 100° C. at atmospheric pressure and which is the reaction product of: a) one or more polyisocyanates with b) one or more polyols having average molecular weights Mₙ of 500 to 6000, c) one or more polyols having average molecular weights Mₙ of 62 to 500, and d) one or more compounds which contain an ionic group or a potential ionic group, 2) in a second step dispersing NCO prepolymer I.1) in water and at least partly neutralizing the potential ionic groups to form ionic groups before, during or after the dispersion,
3) in a third step chain extending NCO prepolymer I.1) with e) one or more polyamines having average molecular weights Mₙ of below 500, and 4) in a fourth step removing the solvent completely by distillation, and ubsequently II) adding 1% to 7% by weight of an ethylene or propylene glycol ether and optionally other coating additives together or separately to polyurethane dispersion I). The present invention also relates to the aqueous coating composition obtained by the process of the invention.

### BACKGROUND OF THE INVENTION

1. Field of the Invention

The present invention relates to a process for preparing solvent-free, aqueous polyurethane coating compositions, and to the resulting coating compositions having improved film-forming properties.

2. Description of Related Art

With the objective of lowering the emissions of organic solvents the use of aqueous coating compositions in place of solventborne systems is on the increase. One important class of aqueous coating binders are the polyurethane dispersions, already described comprehensively in the prior art. In principle it is possible to obtain solvent-free polyurethane dispersions (PUD) by the acetone process or by the prepolymer mixing process. However, PUD's, especially those intended to form relatively hard coatings at or below room temperature, require a coalescing agent that lowers the minimum film formation temperature.

Numerous applications use N-methylpyrrolidone (NMP) as a solvent due to its unreactivity with isocyanate groups and its suitability for reducing the viscosity during prepolymer synthesis. Also, NMP is capable of dissolving dimethylol propionic acid, which is widely used in PUD chemistry. This ensures that a sufficiently large number of hydrophilic centers in the form of carboxylate groups can be incorporated into the polyurethane backbone. Nevertheless it has emerged that NMP is to be classed as a developmental toxin and thus a substitute is needed for this solvent.

DE-A 36 13 492 describes a process for preparing cosolvent-free dispersions by a process known as the acetone process. In that process a 20% to 50% strength organic solution of a hydrophilic polyurethane which has already undergone chain extension is prepared, in acetone for example, and then converted into a dispersion by the addition of water. Removing the acetone by distillation produces a solvent-free dispersion. These PUD's preferably have nonionic hydrophilic groups and can be dried at room temperature to give hard, transparent films. If it is necessary to lower the film-forming temperature or to retard the drying, coalescing solvents are used, such as diacetone alcohol, NMP, ethylene glycol monobutyl ether or diethylene glycol monobutyl ether, in amounts <5% by weight, based on the weight of the dispersion (column 11, 11. 58-65). Disadvantages of these systems are that the products lack adequate water resistance and ethanol resistance and that for a sufficient processing time the use of coalescing solvents is advised. Another disadvantage of this process is the comparatively large solvent volume, requiring removal by distillation after the dispersing step.

An object of the present invention is to provide polyurethane dispersions exclusively having ionic hydrophilic groups and that are free from NMP and other solvents. It is an additional object of the present invention for the coating compositions to possess improved film-forming properties, and for the coatings produced therefrom to effectively resist chemicals and water, and to have hardnesses of more than 75 pendulum seconds.

Surprisingly, these objectives may be achieved with the polyurethane dispersions of the present invention, which are prepared using a low-boiling solvent that is removed by distillation following dispersion and which are then admixed with high-boiling (boiling point >150° C.) ethylene or propylene glycol ethers and optionally other paint additives. These solvent-containing dispersions form films, especially on absorbent substrates, more effectively than those containing other cosolvents, such as NMP, in the same amount. The dispersions containing glycol cosolvents have minimum film formation temperatures of less than 20° C. and result in hard, particularly high-value coatings having very good optical properties, which can be used even on absorbent substrates such as wood.

### SUMMARY OF THE INVENTION

The present invention relates to a process for preparing an aqueous coating composition by
I) preparing a polyurethane dispersion that is free from NMP and other solvents by
   1) preparing in a first step an NCO prepolymer solution which has a concentration of 66% to 98% by weight in a solvent having a boiling point of below 100° C. at atmospheric pressure and which is the reaction product of:
      a) one or more polyisocyanates with
      b) one or more polyols having average molecular weights Mₙ of 500 to 6000,
      c) one or more polyols having average molecular weights Mₙ of 62 to 500, and
      d) one or more compounds which contain an ionic group or a potential ionic group,
   2) in a second step dispersing NCO prepolymer-I.1) in water and at least partly neutralizing the potential ionic groups to form ionic groups before, during or after the dispersion,
   3) in a third step chain extending NCO prepolymer I.1) with
      e) one or more polyamines having average molecular weights Mₙ of below 500, and
   4) in a fourth step removing the solvent completely by distillation, and subsequently
II) adding 1% to 7% by weight of an ethylene or propylene glycol ether and optionally other coating additives together or separately to polyurethane dispersion I).

The present invention also relates to the aqueous coating composition obtained by the process of the invention.

### DETAILED DESCRIPTION OF THE INVENTION

The polyurethane dispersion of the invention preferably has a hard segment content (HS) of 50% to 85% by weight, more preferably 55% to 75% by weight; and an amount of isocyanate, based on resin solids, of 35% to 55% by weight, preferably 39% to 50% by weight. The acid number of the solid resin is 12 to 30 mg KOH/g solid resin, preferably 15 to 28 mg KOH/g solid resin. The hard segment content is calculated as follows:

$$HS = \frac{100 * [ ( mass ( a ) + mass ( c ) + mass ( d ) + mass ( e ) ]}{\sum mass ( a , b , c , d , e )}$$

Suitable polyisocyanates a) are those known from polyurethane chemistry, such as diisocyanates of the formula R¹(NCO)₂, wherein R¹ is an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. Examples of preferred diisocyanates are tetramethylene diisocyanate, hexamethylene diisocyanate, 4,4′-diisocyanatodiphenylmethane, 2,4′-diisocyanatodiphenylmethane, 2,4-diisocyanatotoluene, 2,6-diisocyanatotoluene, α,α,α,‘α,’-tetramethyl-m- or p-xylylene diisocyanate, and mixtures thereof. Particularly preferred diisocyanates are 1-isocyanato-3,3,5-trimethyl-5-isocyanatomethylcyclohexane (isophorone diisocyanate) and 4,4′-diisocyanatodicyclohexylmethane.

Optionally, it is possible to use small amounts of isocyanates having functionalities of three or more to provide a certain degree of branching or crosslinking in the polyurethane. The amount of polyisocyanate to be used is determined by its functionality and should be such that the NCO prepolymer remains stirrable and dispersible. Suitable polyisocyanates include those obtained by reacting divalent isocyanates with one another such that some of their isocyanate groups are derivatized to isocyanurate, biuret, allophanate, uretdione or carbodiimide groups. Polyisocyanates of this type, which are rendered hydrophilic with ionic groups, are also suitable. Examples of these polyisocyanates are described in EP-A 510 438, in which polyisocyanates are reacted with OH-functional carboxyl compounds. Hydrophilic polyisocyanates may also be obtained by reacting polyisocyanates with isocyanate-reactive compounds which contain sulphuric acid groups. These polyisocyanates may have high functionalities of more than 3.

Suitable polymeric polyols b) have a molecular weight range (Mₙ) of 500 to 6000, preferably 500 to 3000 and more preferably 650 to 2500; and an OH functionality of at least 1.8 to 3, preferably 1.9 to 2.2 and more preferably 1.92 to 2.0. The polyols include polyesters, polyethers based on propylene oxide and/or tetrahydrofuran, polycarbonates, polyester carbonates, polyacetals, polyolefins, polyacrylates and polysiloxanes. Preferred are polyesters, polyethers, polyester arbonates and polycarbonates. Particularly preferred are difunctional polyesters, polyethers, polyester carbonates and polycarbonates. Mixtures of polymeric polyols b) are also suitable.

Additionally, in a blend with stated polyols b), it is also possible to use fatty acid-containing polyesters b1), which are the esterification or transesterification product(s) of drying and/or non-drying fatty acids and/or oils with polyol compounds having a functionality of at least two, which are described, for example, in EP-A 0 017 199 (p. 10, 1. 27 to p. 11, 1. 31). The polyol compounds used are preferably trifunctional and tetrafunctional hydroxyl components such as trimethylolethane, trimethylolpropane, glycerol or pentaerythritol.

Also suitable as polyol b1) is partially dehydrated castor oil, which is obtained by the thermal treatment of castor oil under acidic catalysis and is described in EP-A 0 709 414 (p. 2, 11. 37-40).

Also suitable as polyols b1) are those disclosed in DE-A 199 30 961 (p. 2, 11. 46-54; p. 2, 1. 67 to p. 3, 1. 3). In that publication, aliphatic and cycloaliphatic monocarboxylic acids having 8 to 30 carbon atoms, such as oleic acid, lauric acid, linoleic acid or linolenic acid, are reacted with castor oil in the presence of glycerol.

Other suitable polyols b1) are transesterification products of castor oil and one or more other triglycerides.

Particularly preferred as component b1) are fatty acid components which on average having an OH functionality of 2 and which contain glycerol units or trimethylolpropane units. Very particularly preferred are products having average OH functionalities of 2, and obtained by the transesterification of castor oil with a further oil other than castor oil. The fatty acid-containing polyesters b1) are used preferably with polyols b) having an Mₙ of 650 to 2500 g/mol and OH functionalities of 1.92 to 2. The fatty acid-containing polyesters b1) are more preferably used with polyols b) which have an Mₙ of 650 to 2500 g/mol and OH functionalities of 1.92 to 2 and are selected from esters, ethers, carbonates or carbonate esters.

Low molecular weight polyols c) have a molecular weight range (Mₙ) of 62 to 500, preferably 62 to 400 and more preferably 90 to 300. Examples include the difunctional alcohols known from polyurethane chemistry, such as ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, diols containing ether oxygen (such as diethylene glycol, triethylene glycol, tetraethylene glycol, dipropylene glycol, tripropylene glycol, polyethylene, polypropylene or polybutylene glycols), and mixtures thereof. It is also possible to use a minor amount of monofunctional alcohols having 2 to 22, preferably 2 to 18 carbon atoms. Examples include ethanol, 1-propanol, 2-propanol, n-butanol, secondary butanol, n-hexanol and its isomers, 2-ethylhexyl alcohol, ethylene glycol monomethyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, 1-octanol, 1-dodecanol, 1-hexadecanol, lauryl alcohol and stearyl alcohol.

Alcohols having the stated molecular weight range and a functionality of three or more can also be used in an amount such that the polymer solution remains stirrable.

Suitable low molecular weight compounds d) which contain ionic groups or potential ionic groups include dimethylolpropionic acid, dimethylolbutyric acid, hydroxypivalic acid, reaction products of (meth)acrylic acid and polyamines (e.g. DE-A-19 750 186, p. 2, 11. 52-57) or polyol compounds containing sulphonate groups, such as the propoxylated adduct of sodium hydrogensulphite with 2-butenediol or the polyesters described in EP-A 0 364 331 (p. 6, 11. 1-6) and synthesized from salts of sulphoisophthalic acid. Also suitable are OH-functional compounds which contain cationic groups or potential cationic groups, such as N-methyldiethanolamine. Preferred are compounds containing carboxylic acid groups. Dimethylol propionic acid is particularly preferred.

The NCO prepolymer preferably does not contain nonionic hydrophilic groups.

Suitable neutralizing components for the anionic dispersions include the known tertiary amines, ammonia and alkali metal hydroxides. The cationic resins are converted to the water-soluble form by protonation or quaternization.

Suitable chain extenders e) include amino polyols or polyamines having a molecular weight below 500, such as hydrazine, ethylenediamine, 1,4-diaminobutane, isophoronediamine, 4,4′-diaminodicyclohexylmethane, ethanolamine, diethanolamine, piperazine or diethylenetriamine.

In addition to the use of isocyanate-reactive, polyfunctional compounds, the polyurethane prepolymers may be terminated with monofunctional alcohols or amines to regulate the molecular weight of the polyurethanes. Preferred compounds are aliphatic monoalcohols or monoamines having 1 to 18 carbon atoms. Particularly preferred are ethanol, n-butanol, ethylene glycol monobutyl ether, 2-ethylhexanol, 1-octanol, 1-dodecanol, 1-hexadecanol or N-dialkylamines.

Suitable solvents for preparing polyurethane dispersion I) are those which boil below 100° C. under atmospheric pressure, contain no isocyanate-reactive groups and are water-soluble. It must also be possible to remove the solvent by distillation from the dispersion prepared. Examples of these solvents include acetone, methyl ethyl ketone, tert-butyl methyl ether or tetrahydrofuran.

The preparation of the solvent-free, aqueous polyurethane dispersions proceeds in four steps. First the NCO prepolymer is prepared by reacting an excess of component a) with components b), c) and d). Preferably, the NCO prepolymer has an NCO functionality of <2.3. The solvent can be added before, during or after polymerization in an amount sufficient to form a 66% to 98% solution, preferably a 75% to 95% solution. The neutralizing agent for neutralizing the potential ionic groups may be present at the beginning of the reaction, may be added to the finished prepolymer, or may be added to the dispersing water. Alternatively, the amount of neutralizing amine can be divided between the organic and aqueous phase prior to dispersion.

In a second step the NCO prepolymer is dispersed by either adding water to the resin or by adding the resin to water under adequate shearing conditions. In the third step chain extension is carried out using an amount of nitrogen-containing, isocyanate-reactive compounds e) that is sufficient to react with 25% to 105%, preferably 55% to 100%, more preferably 60% to 90% of the isocyanate groups.

The remaining isocyanate groups react with the water present, resulting in chain extension. In the fourth step the solvent is completely removed by distillation, preferably under reduced pressure.

“Solvent-free” according to the present application means that the dispersions contains ≦0.9% by weight, preferably ≦0.5% by weight and particularly preferably ≦0.3% by weight of solvent.

The solids content of the solvent-free dispersion is 25% to 65% by weight, preferably 30% to 50% by weight, more preferably 34% to 45% by weight.

To prepare the coating composition of the invention the solvent-free dispersion is mixed with 1% to 7% by weight, preferably 1% to 5% by weight, based on dispersion from I), of a monohydroxy ethylene or propylene glycol ether or a mixture of such ethers. Examples of monohydroxy ethylene or propylene glycol ethers include ethyl glycol methyl ether, ethyl glycol ethyl ether, diethyl glycol ethyl ether, diethyl glycol methyl ether, triethyl glycol methyl ether, butyl glycol, butyl diglycol, propylene glycol methyl ether, dipropylene glycol methyl ether, tripropylene glycol methyl ether, propylene glycol butyl ether, propylene glycol propyl ether, dipropylene glycol propyl ether, propylene glycol butyl ether, propylene glycol phenyl ether and ethylene glycol phenyl ether. Preferred are ethyl glycol monomethyl ether, butyl glycol, butyl diglycol, propylene glycol monomethyl ether and propylene glycol monobutyl ether.

The ether or ether mixture, provided that the components are water-soluble, is preferably added in the form of an aqueous solution, accompanied by stirring. Water-insoluble components are added to the dispersion slowly with stirring. It is also possible to use minor amounts of ethylene or propylene glycol ethers which contain no OH groups, such as ethyl glycol dimethyl ether, triethyl glycol dimethyl ether, diethyl glycol dimethyl ether or Proglyde® DMM (dipropylene glycol dimethyl ether) from Dow Chemicals (Schwalbach, Germany).

The cosolvent-containing coating composition may also contain the known coating additives such as defoamers, devolatilizers, thickeners, flow control additives or surface additives.

A known defoamer is preferably added first, with stirring. Suitable defoamers include mineral oil defoamers, silicone defoamers, polymeric, silicone-free defoamers, and polyethersiloxane copolymers.

Suitable devolatilizers include polyacrylates, dimethylpolysiloxanes, organically modified polysiloxanes such as polyoxyalkyldimethylsiloxanes, and fluorosilicones.

Thickeners may be used to adjust the viscosity of the coating compositions in accordance with the intended application. Suitable thickeners are known and include natural organic thickeners such as dextrins or starch; organically modified natural substances such as cellulose ethers or hydroxyethylcellulose; all-synthetic organic thickeners such as poly(meth)acrylic compounds or polyurethanes; and inorganic thickeners such as bentonites or silicas. Preferred are all-synthetic organic thickeners, more preferably acrylate thickeners, which if desired are diluted further with water prior to being added.

It is also possible to add flow control additives or surface additives such as silicone additives, ionogenic or nonionogenic acrylates or low molecular weight, surface-active polymers.

Substrate-wetting silicone surfactants, such as polyether-modified polydimethylsiloxanes, may also be added.

The addition of the ether-containing solvents and coating additives can be made as described above, preferably with a time offset, or they can be added simultaneously by adding the ether-containing solvents and the coatings additives together, or by adding a mixture of ether-containing solvents and coatings additives, to polyurethane dispersion I). The mixture of additives and ether-containing solvents can also be added to dispersion I).

The preparation of the coating composition takes place at temperatures 5 to 50° C., preferably 20 to 35° C. The resulting coating compositions can be applied as a physically drying one-component (1K) system or as a two-component (2K) system.

The present invention also relates to the use of the aqueous coating compositions of the invention as binders in one-component (1K) systems or as binder components in a two-component (2K) systems.

In 2K systems the dispersions of the invention are preferably cured with the known hydrophilic and/or hydrophobic lacquer polyisocyanates. When using lacquer polyisocyanates it may be necessary to dilute them with further quantities of cosolvent in order to achieve effective mixing of the polyisocyanates with the dispersion. Suitable solvents include those which are unreactive towards isocyanate groups, such as ethyl glycol dimethyl ether, triethyl glycol dimethyl ether, diethyl glycol dimethyl ether, Proglyde® DMM (dipropylene glycol dimethyl ether), butyl acetate, methoxybutyl acetate or dibasic esters, e.g., those available from DuPont.

The coating compositions can be applied to any desired substrates, such as wood, metal, plastic, paper, leather, textiles, felt, glass or mineral substrates, and also to substrates which have previously been coated. One particularly preferred application is the use of the aqueous coating compositions of the invention for producing coatings on absorbent substrates such as wood or open-pored mineral substrates.

The coating compositions of the invention may be used in combination with other known additives from coatings technology, such as fillers and pigments.

The coating compositions containing the polyurethane dispersions of the invention can be applied in known manner, for example, by spreading, pouring, knife coating, injecting, spraying, spin coating, rolling or dipping.

### EXAMPLES

TABLE 1
Components employed

| Trade name | Designation | Manufacturer |
|---|---|---|
| Desmodur ® W | 4,4′-Diisocyanatodicyclohexylmethane | Bayer AG, Leverkusen, DE |
| Desmodur ® I | Isophorone diisocyanate | Bayer AG, Leverkusen, DE |
| Bayhydur ® VP LS | Hydrophilic | Bayer AG, Leverkusen, DE |
| 2236 | polyisocyanate; 16.2% by | |
| | weight NCO | |
| Proglyde ® DMM | Dipropylene glycol | Dow Chemicals, Schwalbach, |
| | dimethyl ether | DE |
| PolyTHF ® | Polytetramethylene | BASF AG, Ludwigshafen, DE |
| | glycol, | |
| | F = 2, MW ≈ 2000 g/mol | |
| Byk ® 381 | Flow control aid | Byk Chemie, Wesel, DE |
| Byk ® 346 | Wetting agent | Byk Chemie, Wesel, DE |
| Byk ® 028 | Defoamer | Byk Chemie, Wesel, DE |
| Acrysol ® RM8 | Thickener, 5% in water | Rohm & Haas, Frankfurt, DE |
| Dowanol ® TPnB | Tripropylene glycol butyl | DOW Chemicals, Schwalbach, |
| | ether | DE |
| Dowanol ® PnB | Propylene glycol butyl | DOW Chemicals, Schwalbach, |
| | ether | DE |

Polyester Oligomer Precursor

A 5 liter reactor equipped with top-mounted distillation unit was charged with 3200 g of castor oil and 1600 g of soya oil and also with 2.0 g of dibutyltin oxide. A stream of nitrogen (5 l/h) was passed through the reactants. Over the course of 140 minutes this initial charge was heated to 240° C. and after 6 h at 240° C. was cooled. The resulting product had an OH number of 108 mg KOH/g and an acid number of 2.5 mg KOH/g.

Dispersion 1

205.5 g of a polyester polyol (adipic acid, 1,6-hexanediol; OH number 66 mg KOH/g), 19 g of dimethylolpropionic acid and 58.0 g of 1,6-hexanediol were dewatered under reduced pressure at 110° C. The dewatered mixture was then cooled to 55° C., admixed in succession with 124.2 g of acetone and 226.9 g of Desmodur® I and boiled under reflux until an NCO content of 3.9% by weight (theoretical NCO content 4.0%) was reached. The batch was again adjusted to 55° C. and the clear solution was admixed with 12.9 g of triethylamine, which was stirred in thoroughly. The whole neutralized prepolymer solution (55° C.) was dispersed with vigorous stirring in 770 g of water which was at a temperature of 30° C. Dispersion was followed by stirring for 5 minutes, after which, over the course of 5 minutes, a solution of 4.2 g of hydrazine hydrate and 9.2 g of ethylenediamine dissolved in 90 g of water was added. Subsequently the acetone was completely removed by distillation at 40° C. under reduced pressure (120 mbar). For reaction of the remaining isocyanate groups, the batch was stirred at 40° C. until NCO was no longer detected by IR spectroscopy. Cooling to 30° C. was followed by filtration through a Seitz T5500 filter.

Properties of the polyurethane dispersion:

| | |
|---|---|
| Average particle size: | 60 nm (laser correlation |
| | spectroscopy, LCS) |
| pH (20° C.) (10% strength aqueous solution.): | 7.8 |
| Solids content: | 35.0% |
| Hard segment content: | 61% |
| Acid number (based on solid resin): | 15.5 mg KOH/g |

Dispersion 2

A mixture of 181.0 g of PolyTHF® 2000, 140.3 g of the polyester oligomer precursor, 37.2 g of dimethylolpropionic acid and 18.3 g of 1,6-hexanediol was admixed at 55° C. with 98.9 g of acetone and 19.6 g of triethylamine and mixed. 275.4 g of Desmodur® W were added and the reaction mixture was boiled at reflux until an NCO content of 4.3% was reached. 500 g of the prepolymer were dispersed with vigorous stirring in 720 g of water which was introduced at a temperature of 30° C. After 5 minutes, over the course of 5 minutes, a solution of 4.2 g of hydrazine hydrate and 6.2 g of ethylenediamine in 73 g of water was added. For complete reaction of the isocyanate groups the batch was stirred at 45° C. until NCO was no longer detected by IR spectroscopy. Cooling was followed by filtration through a Seitz T5500 filter.

Properties of the polyurethane dispersion:

| | |
|---|---|
| Average particle size (LCS): | 55 nm |
| pH (20° C.) (10% strength aqueous solution): | 8.4 |
| Solids content: | 35.0% |
| Hard segment content: | 52% |
| Acid number (based on solid resin): | 23.3 mg KOH/g |

Comparative Dispersion 3 (Containing NMP)

300.7 g of a polyester polyol (adipic acid, 1,6-hexanediol; OH number 66 mg KOH/g), 27.8 g of dimethylolpropionic acid and 84.8 g of 1,6-hexanediol were dewatered under reduced pressure at 110° C. The mixture was then cooled to 90° C. and 181.7 g of NMP* were added to provide a clear solution which 332.1 g of Desmodur® I, heated to 70° C., were added. Stirring took place at 90° C. until the NCO content was 3.8% by weight (theoretical NCO content 4.0%). Subsequently at 70° C. 21.0 g of triethylamine were added and were stirred in for 10 minutes. 700 g of the neutralized solution were dispersed with vigorous stirring in 810 g of water which was at a temperature of 30° C. Dispersion was followed by stirring for 5 minutes, after which, over the course of 5 minutes, a solution of 4.2 g of hydrazine hydrate and 9.2 g of ethylenediamine dissolved in 90 g of water was added. For complete reaction of the isocyanate groups, the batch was stirred at 40° C. until NCO was no longer detected by IR spectroscopy. Cooling to 30° C. was followed by filtration through a Seitz T5500 filter.

Properties of the polyurethane dispersion:

| Average particle size (LCS): | 60 nm |
|---|---|
| pH (20° C.) (10% strength aqueous solution.): | 7.8 |
| Solids content: | 35.0% |
| Cosolvent content: | 8.3% |

An attempt to reduce the amount of NMP to give a dispersion with a cosolvent content of 5% resulted in a highly viscous resin melt which could not be completely dispersed.

### Comparative Example 4 (Containing NMP)

339 g of PolyTHF® 2000, 248 g of the polyester oligomer precursor, 70 g of dimethylolpropionic acid, 34 g of 1,6-hexanediol and 186 g of N-methylpyrrolidone were heated to 70° C. and stirred until a clear solution was formed. Then 516 g of Desmodur® W were added and the mixture was heated to 100° C. It was stirred at this temperature until the NCO content was 4.6% and was then cooled to 70° C. At that temperature 39 g of triethylamine were added. 500 g of this solution were then dispersed with vigorous stirring in 640 g of water which had been introduced at a temperature of 30° C. Dispersion was followed by stirring for 5 minutes, after which, over the course of 5 minutes, a solution of 4.1 g of hydrazine hydrate and 10.2 g of ethylenediamine in 100 g of water was added. For complete reaction of the isocyanate groups, the batch was stirred at 45° C. until NCO was no longer detected by IR spectroscopy. Cooling to 30° C. was followed by filtration through a Seitz T5500 filter.

Properties of the polyurethane dispersion:

| Average particle size (LCS): | 45 nm |
|---|---|
| pH (20° C.) (10% strength aqueous solution): | 8.2 |
| Solids content: | 35.0% |
| Cosolvent content | 5.1% |

### Comparative Example 5

500.0 g of a polyester polyol formed from adipic acid, 1,6-hexanediol and neopentyl glycol (molar ratio of diols 0.65:0.35, OH number 66 mg KOH/g) and 59.0 g of a second polyester polyol formed from adipic acid and 1,6-hexanediol (OH number 133 mg KOH/g) were mixed with 31.5 g of 1,4-butanediol, 43 g of a polyether formed from a mixture of 84% ethylene oxide and 16% propylene oxide and initiated with n-butanol (OH number 26 mg KOH/g), 40.2 g of dimethylolpropionic acid and 13.4 g of trimethylolpropane and the mixture was reacted at 70° C. with 488.0 g of Desmodur® I until the NCO content of the NCO prepolymer was 7.3%. The resulting prepolymer was dissolved in 2420 g of acetone and at 30° C. this solution was admixed with 30.3 g of triethylamine. Added subsequently to the prepolymer solution over the course of 5 minutes was an aqueous solution of 24 g of ethylenediamine, 10.3 g of diethylenetriamine and 310 g of water. After subsequent stirring for 15 minutes, 2110 g of water were added with intensive stirring. The acetone was removed under reduced pressure from the resulting dispersion.

Properties of the polyurethane dispersion:

| Average particle size: | 115 nm |
|---|---|
| pH (20° C.) (10% strength aqueous solution): | 7.4 |
| Solids content: | 35.0% |

Filming Properties of the Dispersions

Cosolvent-free dispersion 2 was divided up and diluted with different cosolvent/water mixtures or, where the cosolvent was not miscible with water, diluted directly with a cosolvent (these are labelled by * in Tab. 1). The cosolvent-containing dispersions obtained were applied to a glass plate using a doctor blade at a wet film thickness of 210 μm. After drying at 20° C., the films were assessed (Table 1).

For comparison, comparative dispersion 4 (5.1% cosolvent content) without further additions was applied in the same film thickness. Drying produced a smooth, transparent and crack-free film.

TABLE 2
Films obtained from cosolvent-free dispersion by addition of different
cosolvents/amounts of cosolvent. 2% (based on dispersion) of a 5%
strength solution of Acrysol ® RM 8 was added as thickener.

| | 3% cosolvent based | 5% cosolvent based |
|---|---|---|
| Cosolvent | on dispersion | on dispersion |
| Butyl glycol | smooth, crack-free | smooth, crack-free |
| Butyl diglycol | smooth, crack-free | smooth, crack-free |
| Tripropylene glycol | smooth, crack-free | smooth, crack-free |
| Dowanol ® TPnB | smooth, crack-free | smooth, crack-free |
| Dowanol ® PnB | smooth, crack-free | smooth, crack-free |
| N-Methylpyrrolidone | numerous long cracks | a few long cracks at |
| | | the margin |

The film-forming properties and hardnesses of different dispersions with different cosolvent contents were investigated (see Tab. 2). 2% (based on the weight of the dispersion) of a 5% strength solution of Acrysol® RM 8 was added as thickener. Ethanol resistance and water resistance were carried out on films drawn down onto wood. The coatings were dried beforehand at room temperature for one day. Ethanol resistance was determined by a five-minute placement of an ethanol-soaked cotton pad on the coating. The cotton pad was covered with a small glass beaker. An analogous procedure was followed using water as the test substance, but the loading was left on the coating for 24 h.

Assessment of resistance properties:
1=poor, coating destroyed

5=very good, coating unchanged

TABLE 3
Film-forming properties and hardnesses

| | Ex. 1 | Ex. 1 | Ex. 2 | Comp. Ex. 5 |
|---|---|---|---|---|
| Dispersion [g] | 100 | 100 | 89.3 | 100 |
| Byk ® 346/Byk ® 381 [g] | 0.2/0.5 | 0.2/0.5 | 0.18/0.45 | 0.2/0.5 |
| Cosolvent | butyl | butyl | butyl | butyl glycol |
| | glycol | glycol | glycol | |
| Cosolvent content [%] on the | 3.7 | 4.8 | 4.0 | 3.7 |
| weight of dispersion | | | | |
| Application temp. | 20° C. | 4° C. | 20° C. | 20° C. |
| Optical properties on untreated wood | very good | very good | very good | very good |
| Optical properties on glass | very good | very good | very good | very good |
| König pendulum hardness after | 115 sec. | 112 sec. | 87 sec. | 102 sec. |
| 2 d/RT, 210 μm wet film thickness | | | | |
| Ethanol resistance | 3 | 3 | 3-4 | 1 |
| Water resistance | 4-5 | 4-5 | 5 | 1 |

TABLE 4
Comparison of 2K systems diluted with NMP or butyl diglycol

| Dispersion | Ex. 1 | Ex. 1 | Ex. 2 | Ex. 2 |
|---|---|---|---|---|
| Amount of dispersion | 76.8 g | 76.8 | 75.3 g | 75.3 g |
| Bayhydur ® VP LS 2336 | 9.0 g | 9.0 g | 9.0 g | 9.0 g |
| 65% in Proglyde ® DMM | | | | |
| NMP/water | | 1.7 g/8.3 g | | 1.7 g/8.3 g |
| Butyl diglycol/water | 1.7 g/ 8.3 g | | 1.7 g/8.3 g | |
| Byk ® 028 | 1.0 | 1.0 | 1.0 | 1.0 |
| Byk ® 346 | 0.2 | 0.2 | 0.2 | 0.2 |
| Byk ® 381 | 0.5 | 0.5 | 0.5 | 0.5 |
| Acrysol ® RM8/water | 1 g/1 g | 1 g/1 g | 1 g/1 g | 1 g/1 g |
| Cosolvent content [%] | 4.9 | 4.9 | 4.9 | 4.9 |
| Application temp. | 4° C. | 4° C. | 4° C. | 4° C. |
| Optical properties on untreated wood | very good | good | very good | few cracks |
| Optical properties on glass | very good | very good | very good | very good |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing aqueous coating composition which comprises
I) preparing a polyurethane dispersion that is free from NMP and other solvents by
1) preparing in a first step a NCO prepolymer solution which has a concentration of 66% to 98% by weight in a solvent having a boiling point of below 100° C. at atmospheric pressure and which is the reaction product of:
a) one or more polyisocyanates with
b) one or more polyols having average molecular weights Mₙ of 500 to 6000,
c) one or more polyols having average molecular weights Mₙ of 62 to 500, and
d) one or more compounds which contain an ionic group or a potential ionic group,
2) in a second step dispersing NCO prepolymer I.1) in water and at least partly neutralizing the potential ionic groups to form ionic groups before, during or after the dispersion,
3) in a third step chain extending NCO prepolymer I.1) with
e) one or more polyamines having average molecular weights Mₙ of below 500, and
4) in a fourth step removing the solvent completely by distillation, and subsequently
II) adding 1% to 7% by weight of an ethylene or propylene glycol ether and optionally other coating additives together or separately to polyurethane dispersion I).

2. An aqueous coating composition which is prepared by a process comprising
I) preparing a polyurethane dispersion that is free from NMP and other solvents by
1) preparing in a first step a NCO prepolymer solution which has a concentration of 66% to 98% by weight in a solvent having a boiling point of below 100° C. at atmospheric pressure and which is the reaction product of:
a) one or more polyisocyanates with
b) one or more polyols having average molecular weights Mₙ of 500 to 6000,
c) one or more polyols having average molecular weights Mₙ of 62 to 500, and
d) one or more compounds which contain an ionic group or a potential ionic group,
2) in a second step dispersing NCO prepolymer I.1) in water and at least partly neutralizing the potential ionic groups to form ionic groups before, during or after the dispersion,
3) in a third step chain extending NCO prepolymer I.1) with
e) one or more polyamines having average molecular weights Mₙ of below 500, and
4) in a fourth step removing the solvent completely by distillation, and subsequently
II) adding 1% to 7% by weight of an ethylene or propylene glycol ether and optionally other coating additives together or separately to polyurethane dispersion I).

3. The aqueous coating composition of claim 2 wherein the polyurethane dispersion has a hard segment content (HS) of 50% to 85% by weight and an amount of isocyanate, based on resin solids, of 35% to 55% by weight.

4. The aqueous coating composition of claim 2 wherein the acid number of the solid resin is 12 to 30 mg KOH/g solid resin.

5. The aqueous coating composition of claim 2 wherein polyols b) comprise a mixture of polyols containing at least one fatty acid-containing polyester.

6. The aqueous coating composition of claim 5 wherein the fatty acid-containing polyester has an average OH-functionality of about 2 and contains glycerol units or trimethylolpropane units.

7. The aqueous coating composition of claim 5 wherein the fatty acid-containing polyester has an average OH functionality of about 2 and comprises the reaction product of the transesterification of castor oil with a further oil other than castor oil.

8. The aqueous coating composition of claim 5 wherein polyols b) have an average molecular weight Mₙ of 650 to 2500 g/mol and OH functionalities of 1.92 to 2 and comprise a member selected from the group consisting of esters, ethers, carbonates and carbonate esters.

9. The aqueous coating composition of claim 2 wherein component II) comprises ethyl glycol monomethyl ether, ethyl glycerol monobutylether, butyl diglycol, propylene glycol monomethyl ether or propylene glycol monobutyl ether.

10. The aqueous coating composition of claim 3 wherein component II) comprises ethyl glycol monomethyl ether, ethylglycerol monobutylether, butyl diglycol, propylene glycol monomethyl ether or propylene glycol monobutyl ether.

11. The aqueous coating composition of claim 4 wherein component II) comprises ethyl glycol monomethyl ether, ethylglycerol monobutylether, butyl diglycol, propylene glycol monomethyl ether or propylene glycol monobutyl ether.

12. The aqueous coating composition of claim 5 wherein component II) comprises ethyl glycol monomethyl ether, ethylglycerol monobutylether, butyl diglycol, propylene glycol monomethyl ether or propylene glycol monobutyl ether.

13. The aqueous coating composition of claim 6 wherein component II) comprises ethyl glycol monomethyl ether, ethylglycerol monobutylether, butyl diglycol, propylene glycol monomethyl ether or propylene glycol monobutyl ether.

14. The aqueous coating composition of claim 7 wherein component II) comprises ethyl glycol monomethyl ether, ethylglycerol monobutylether, butyl diglycol, propylene glycol monomethyl ether or propylene glycol monobutyl ether.

15. The aqueous coating composition of claim 2 wherein the aqueous coating composition is a one-component compositions.

16. The aqueous coating composition of claim 2 wherein the aqueous coating composition is a two-component composition.

17. The aqueous coating composition of claim 16 wherein the aqueous coating composition also contains a hydrophilic or hydrophobic polyisocyanate.

18. A coated substrate which is coated with he aqueous coating composition of claim 2.

19. The coated substrate of claim 18 wherein the substrate is an absorbent substrate.

20. The coated substrate of claim 19 wherein the absorbent substrate is wood or an open-pored mineral substrate.
